(19) United States
(12) Patent Application Publication
(10) Pub. No.: US 2004/0116086 A1
(43) Pub. Date: Jun. 17, 2004

(54) Reception method, radio system and receiver

(76) Inventor: Mikko Huttunen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/725,516

(22) Filed: Dec. 3, 2003

Related U.S. Application Data
(63) Continuation of application No. PCT/FI02/00493, filed on Jun. 7, 2002.

(30) Foreign Application Priority Data
Jun. 8, 2001 (FI) 20011217

(51) Int. Cl. H04B 1/00; H04B 17/02

(52) U.S. Cl. 455/130; 455/132; 455/133

(57) ABSTRACT

A reception method, a receiver and a radio system comprising receivers (RX1, RX2) containing a radio part (RF1, RF2) and a baseband part (BB1, BB2), each receiver using a dedicated narrowband channel (CH1, CH2), the radio part of each receiver being adapted to receive the narrowband channel used by the receiver from the radio path and to forward the received narrowband channel to the baseband part of the receiver for further processing, and the radio part of at least one receiver being adapted to receive at least one other narrowband channel in addition to the channel used by the receiver from the radio path, the system further comprising transmission means for forwarding said at least one other narrowband channel from the radio part of said at least one receiver to the baseband part of at least one other receiver using said other narrowband channel for further processing.

This application is a Continuation of International Application PCT/FI02/00493 filed Jun. 7, 2002, which designated the U.S. and was published under PCT Article 21(2) in English.

### BACKGROUND OF THE INVENTION

The invention relates to reception in a radio system comprising at least two receivers, at least one of which includes a wideband radio part.

As the number of users of wireless radio communication, e.g. cellular systems, increases and rapid data transmission in such systems becomes increasingly common, it is essential to raise the system capacity by improving the performance of the system. One manner of improving reception sensitivity of a base station in a radio system is to divide the base station into sectors by replacing an omnidirectional antenna with directional antennas, each of which covers a particular sector of the base station's operating area. For example, a base station with a fully circular operating area can be divided into e.g. three 120° sectors, each of which is provided with one or more receiving antennas directed to receive radio signals only from their own sector. Furthermore, the receivers are typically sectorised correspondingly, so that each antenna has a dedicated receiver. One sector can thus be covered e.g. by one receiver operating only in this sector. Similarly, transmission can be implemented in a sectorised manner or alternatively in an omnidirectional manner by an omnidirectional antenna. In the present application, the term ‘receiver’ refers to a combination of one or more radio parts and a related baseband part, employing a particular narrowband channel(s) for data transmission. The term ‘narrowband channel’ refers herein to a channel typically containing a modulated carrier of a particular frequency or a modulated group of carriers on a particular frequency band (e.g. Orthogonal Frequency Division Multiplexing, OFDM). A ‘radio part’ refers to a part of a receiver, where one or more narrowband channels are separated from a received radio-frequency signal arriving e.g. from an antenna, and the channels are converted preferably into a baseband or some other similar form. A ‘baseband part’ in turn refers to a part of a receiver, where a baseband narrowband channel used by the receiver is processed further, for example demodulated, which means that the actual information to be transmitted, which has been modulated into the carrier or group of carriers contained by the narrowband channel, is separated therefrom.

A problem with the sectorised arrangement described above is that in particular in public safety and security networks or the like, if a high number of radio resources are required suddenly in one sector e.g. due to an accident in the sector area, the maximum amount of resources that can be provided is limited e.g. by the capacity of one receiver servicing the sector. Even if the base station comprised e.g. three receivers, the other two receivers could only operate in their own sector, wherefore they could not be used to provide radio resources in the sector where the accident occurred.

A possible solution to this problem is providing each base station receiver with an antenna in each sector, so that each receiver is able to operate in every base station sector. Thus, in an accident situation as described above, the sector where the accident occurred could be provided with the total capacity of for example three receivers. For instance, U.S. Pat. No. 5,535,423 discloses an arrangement where one receiver operates in three base station sectors such that the receiver comprises three radio parts, each associated with one antenna operating in a specific sector. The best one of the signals offered by the three different receiver branches is selected for further processing. It should be noted that unlike in the present application, in the US publication the radio part is referred to as a receiver. A problem with such an arrangement is that the receiver is expensive and complicated, since each sector requires a separate radio part. Furthermore, if the base station comprises e.g. three receivers and three sectors and all the receivers are to be used in all the sectors, each receiver requires one radio part for each sector. The antennas can be either specific to a receiver, in which case each receiver has a dedicated antenna in each sector, or specific to a sector so that each sector has one antenna, from which a signal is forwarded to the relevant radio part of each receiver. Furthermore, if diversity reception or phased antenna arrays are to be used, wherein the receiver receives signals from two or more antennas operating e.g. in the same sector, the number of radio parts required increases correspondingly.

### BRIEF DESCRIPTION OF THE INVENTION

An objective of the invention is to provide a method and equipment implementing the method so as to eliminate the aforementioned problems. The objective of the invention is obtained with a method, a system and a receiver characterized by what is disclosed in independent claims 1, 7 and 13. Preferred embodiments of the invention are disclosed in the dependent claims.

According to a basic idea of the invention, in a radio system comprising at least two receivers, at least one of which includes a wideband radio part capable of receiving a wideband frequency band containing at least two narrowband channels, the radio part of said at least one receiver including a wideband radio part is used for receiving at least one narrowband channel other than the channel used by the receiver, and said at least one other narrowband channel is forwarded from the radio part of said receiver to the baseband part of the other receiver using said other narrowband channel for further processing. In other words, the wideband radio part of one or more receivers is also used to receive channels used by other system receivers.

An advantage of the method and the system according to the invention is that the number of receiving branches per receiver can be increased without having to add radio parts in the same proportion. This simplifies considerably the implementation of the radio system, thus greatly reducing costs.

### BRIEF DESCRIPTION OF THE FIGURES

The invention will be described below in more detail in connection with preferred embodiments and with reference to the accompanying drawings, in which

FIG. 1 shows a block diagram of a receiver structure,

FIG. 2 shows a block diagram of a radio system according to an embodiment of the invention,

FIG. 3 shows placement of antennas in a sectorised cell according to an embodiment of the invention,

FIG. 4 shows a block diagram of a radio system according to an embodiment of the invention,

FIG. 5 shows placement of antennas in a sectorised cell according to an embodiment of the invention, and

FIG. 6 shows a block diagram of a radio system according to an embodiment of the invention.

### DETAILED DESCRIPTION OF THE INVENTION

The invention will be described below mainly in connection with a terrestrial trunked radio (TETRA) system, without restricting the invention thereto, however. The invention can also be applied to other radio systems, such as the GSM, and 3G UMTS and OFDM-based systems.

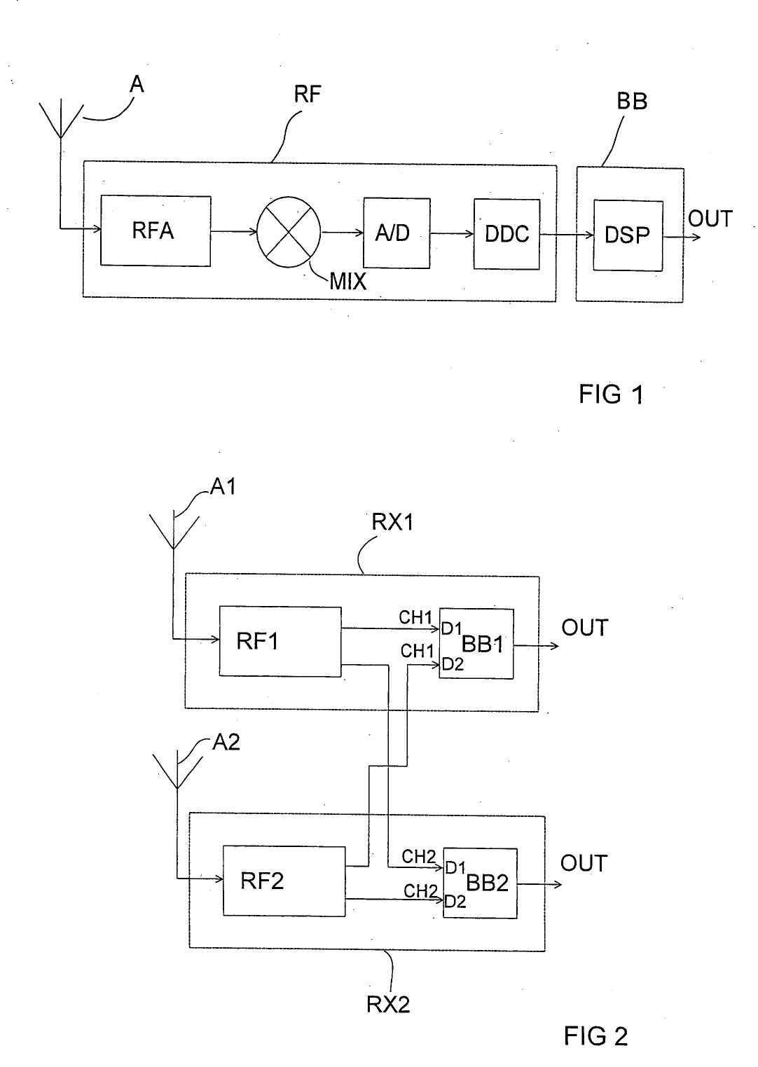

FIG. 1 illustrates a receiver structure. The receiver can be divided into two main blocks: a radio part RF and a baseband part BB. The figure also shows an antenna A connected to the receiver. The receiver can also comprise several parallel radio parts RF. It should be noted that for the sake of simplicity, the figure shows a block diagram of the receiver only generally. Details that are irrelevant to the invention are not shown, as they are evident to those skilled in the art. For example, possible filters are not shown. A radio-frequency signal arriving from the antenna A is amplified preferably in a radio-frequency amplifier RFA. The RFA preferably amplifies the frequency band where the received signal is located. For example in a TETRA system, a possible frequency range is between 380 and 400 MHz, and the interval between carriers is 25 kHz, which means that a frequency band containing one carrier has a width of 25 kHz. Between the frequency bands allocated to the carriers there are typically guard bands. The radio part RF can be either narrowband or wideband. ‘Narrowband’ means herein that the radio part receives a frequency band containing substantially one narrowband channel. A ‘narrowband channel’ in turn refers herein to a channel containing one carrier, e.g. in a TETRA system a band of about 25 kHz. A medium frequency of a narrowband channel is typically the frequency of the carrier wave contained by the channel. ‘Wideband’ in turn means that the radio part receives a frequency band containing two or more narrowband channels, i.e. a wideband channel, which means e.g. in a TETRA system a frequency band of about 50 kHz or more. It should be noted that the frequency and bandwidth values cited above as examples naturally concern a radio-frequency signal. When a radio-frequency narrowband channel is converted for example into an intermediate frequency or a baseband, these values, such as the medium frequency of the channel or the frequency of the carrier, also change correspondingly. In other words, a particular narrowband channel can have a different medium frequency and/or bandwidth in different parts of the system. However, the information content modulated into the carrier contained by the channel remains the same through the entire system. The aforementioned narrowband and wideband channels should not be confused with physical and logical channels of the TETRA system, for instance. In a time-division TETRA system, one carrier contains four physical channels, which consist of four successive time slots, each of which is allocated to a particular physical channel. These physical channels can be used further to form logical channels. However, a channel refers below to a transmission channel containing one or more carriers, unless otherwise stated. After the amplifier RFA, the radio-frequency signal can be mixed to a lower frequency, i.e. intermediate frequency, in a mixer stage MIX. It should be noted that there can be several intermediate stages or no such stage. The signal is thereafter preferably sampled into a digital form in an A/D converter. The sampling frequency used depends on the frequency and bandwidth of the signal to be digitised. The signal is thereafter applied to a digital down converter DDC, where it is converted into a baseband. At the same time, for example a possibly I/Q-modulated signal can be subjected to I/Q demodulation to form separate I signals and Q signals. In the DDC, the received signal is also channelled, which means that the one or more narrowband channels contained in the received signal are separated therefrom. The output of the radio part RF thus provides one or more, preferably baseband, narrowband channels containing one carrier, the channels being forwarded to the baseband part BB. The BB comprises a preferably digital signal processor DSP or the like, which further processes the one or more narrowband channels. Further processing includes e.g. demodulation of the narrowband channel, so that the information signal modulated into the carrier of the channel is separated therefrom. The information signal thus obtained can also be subjected to other measures before it is forwarded further in the receiver. The operation of the down converter DDC and the digital signal processor DSP described above need not be illustrated in more detail herein, since the exact operation thereof depends on the system to which the invention is applied. Such elements are also provided by several manufacturers for example in the form of an integrated microcircuit. An example of a down converter is circuit AD6624 manufactured by Analog Devices Inc., Norwood, Mass., USA, and an example of a digital signal processor is TMS 320C6416 manufactured by Texas Instruments Inc., Dallas, Tex., USA. It should be noted that the above illustration is only an example of the receiver structure. However, the invention is not restricted to such a structure, nor is it restricted to a particular frequency. The terms ‘radio-frequency’, ‘intermediate-frequency’ and ‘baseband’ should be understood as only illustrative. The essential fact with respect to the invention is that in the radio part, one or more narrowband channels are separated from the received radio signal, and in the baseband part the actual information signal is separated from one or more narrowband channels.

FIG. 2 shows a radio system comprising two receivers RX1 and RX2 according to an embodiment of the invention. Receiver RX1 is connected to antenna A1 and receiver RX2 to antenna A2. Receivers RX1 and RX2 utilize narrowband channels CH1 and CH2, respectively. Both the radio part RF1 of receiver RX1 and the radio part RF2 of receiver RX2 are wideband in this example, and according to the invention they receive at least one other narrowband channel CH1 or CH2 in addition to the narrowband channel CH1 or CH2 used by the receiver. Radio parts RF1 and RF2 thus receive a wideband channel containing two narrowband channels CH1 and CH2. In receiver RX1, channel CH1 used by the receiver is usually forwarded to a baseband part BB1 for further processing, and in receiver RX2 channel CH2 used by the receiver is generally forwarded to a baseband part BB2 for further processing. Furthermore, according to the invention narrowband channel CH2 received by radio part RF1 of receiver RX1 is forwarded to baseband part BB2 of receiver RX2 for further processing, and similarly narrowband channel CH1 received by radio part RF2 of receiver RX2 is forwarded to baseband part BB1 of receiver RX1 for further processing. Thus, the baseband parts BB1 and BB2 of both receivers RX1 and RX2 obtain two different versions D1 and D2 of the narrowband channel CH1 or CH2 they use, the versions arriving from different sources. In baseband part BB1 or BB2, the different versions D1 and D2 of the same channel CH1 or CH2 can thus be utilized according to any known diversity reception method or combining method, depending on the system. The channel versions D1, D2 can be e.g. combined, or the better one can be selected for further processing according to some criterion. However, the manner in which the versions of channel CH1 or CH2 received through different paths are used in baseband part BB1 or BB2 is not essential for the basic idea of the invention. It is also possible that only one of receivers RX1 and RX2 includes a wideband radio part, in which case the other receiver comprises a narrowband radio part. In such a case, only the wideband radio part is able to forward an alternative channel signal to the baseband part of the other receiver. Receivers RX1 and RX2 can be located physically in the same unit or remotely from one another. They can comprise common components, even though they are shown in the figures as entirely separate. For example, the baseband parts BB1 and BB2 of the receivers can be implemented by a common signal processor comprising two logically separate branches BB1 and BB2. Similarly, for example possible A/D converters and/or down converters (DDC) of the radio parts RF1 and RF2 can be implemented by means of a common integrated microcircuit or the like, which comprises separate branches for each receiver RX1, RX2. Furthermore, transmission of channels from radio part RF1 of receiver RX1 to baseband part BB2 of receiver RX2 and correspondingly from radio part RF2 of receiver RX2 to baseband part BB1 of receiver RX1 can be implemented e.g. via a direct connection or a suitable bus, depending on the system used and the distance between the receivers. Examples of such buses are PCI (Peripheral Component Interconnect) and UTOPIA (Universal Test & Operations Interface for ATM).

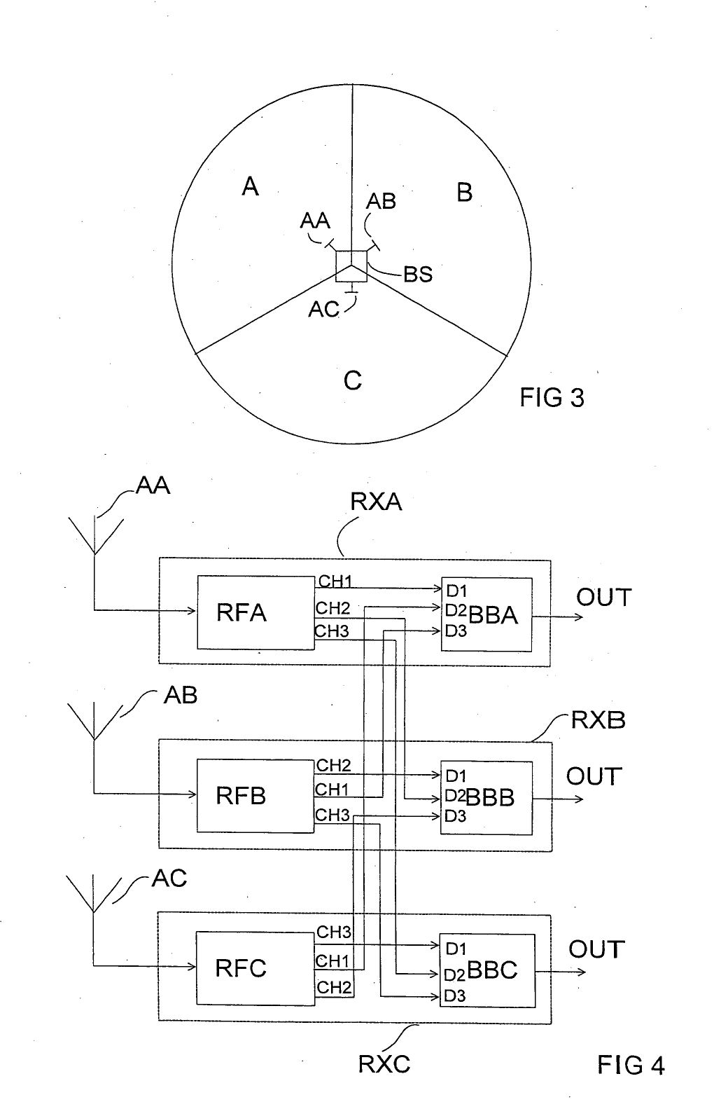

FIG. 3 shows a cell formed by a radio system base station BS, divided into three sectors A, B and C. The base station BS is located substantially in the middle of the cell. It should be noted that there can be e.g. an arbitrary number of sectors and the cell shape can differ from the one described herein without any significance to the basic idea of the invention. The base station BS is associated with three directional antennas intended for radio reception, i.e. antenna AA that operates substantially in sector A, antenna AB that operates in sector B and antenna AC operating in sector C. It should be noted that in the figure, the antennas AA, AB and AC are positioned in an illustrative manner only, and they are not shown to scale. FIG. 4 shows a receiver arrangement of the base station BS of FIG. 3, comprising three receivers RXA, RXB and RXC. Antenna AA of sector A is connected to receiver RXA, antenna AB is connected to receiver RXB and antenna AC to receiver RXC. Receiver RXA utilizes narrowband channel CH1, receiver RXB uses narrowband channel CH2 and receiver RXC uses channel CH3. Radio parts RFA, RFB, RFC of the receivers are all wideband in this example, and according to the invention they receive at least one other narrowband channel in addition to the narrowband channel CH1, CH2 or CH3 used by the receiver in question. In other words, radio parts RFA, RFB and RFC receive a wideband channel containing three narrowband channels CH1, CH2 and CH3. Receiver RXA forwards channel CH1 it uses to baseband part BBA for further processing, receiver RXB forwards channel CH2 it uses to baseband part BBB for further processing, and similarly, receiver RXC forwards channel CH3 it uses to baseband part BBC for further processing. Furthermore, according to the invention narrowband channel CH2 received by radio part RFA of receiver RXA is forwarded to baseband part BBB of receiver RXB for further processing, and narrowband channel CH3 is forwarded to baseband part BBC of receiver RXC for further processing. Similarly, channel CH1 is forwarded from receiver RXB to receiver RXA and channel CH3 is forwarded to receiver RXC. In addition, channel CH1 is forwarded from receiver RXC to receiver RXA and channel CH2 is forwarded to receiver RXB. Thus, the baseband part BBA, BBB and BBC of each receiver RXA, RXB and RXC receives three different versions D1, D2 and D3 of the narrowband channel CH1, CH2 or CH3 it uses from three different sources, each channel version arriving from a different sector A, B or C. Each receiver RXA, RXB and RXC is thus able to operate in each cell sector A, B and C.

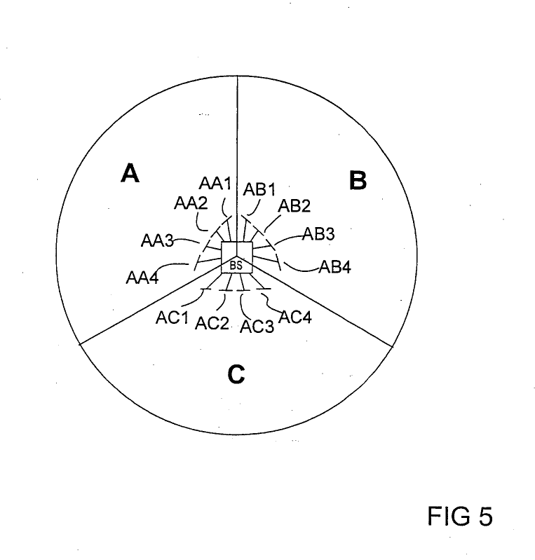

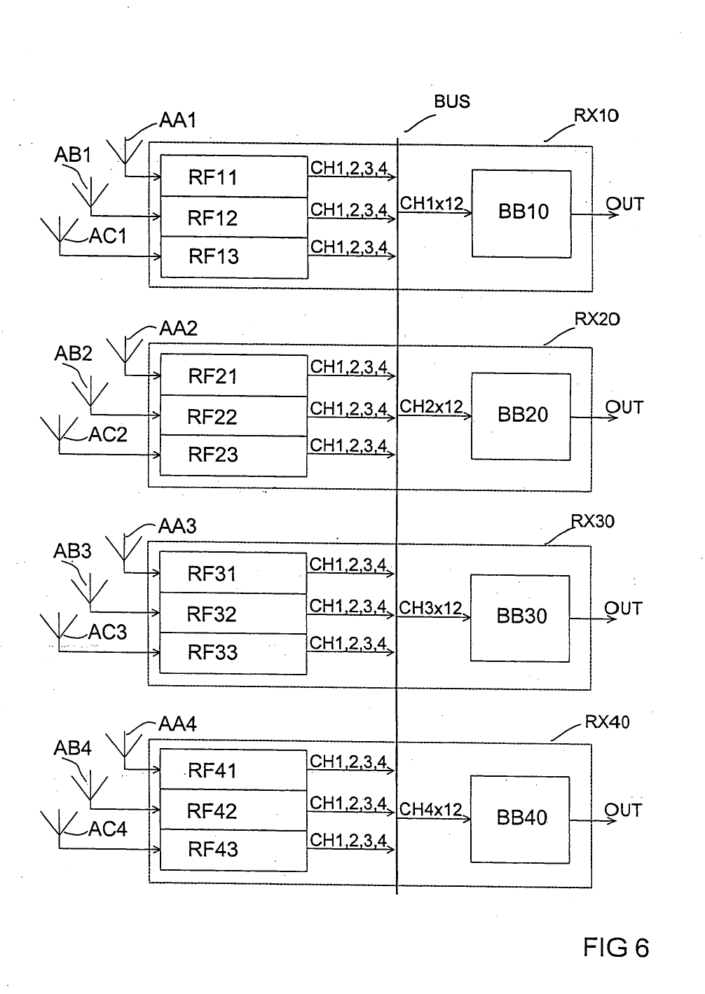

FIG. 5 also shows a cell formed by a radio system base station BS, divided into three sectors A, B and C. The base station BS is associated in this example with 12 directional antennas intended for radio reception, i.e. antennas AA1, AA2, AA3 and AA4 that operate substantially in sector A, antennas AB1, AB2, AB3 and AB4 that operate in sector B, and antennas AC1, AC2, AC3 and AC4 operating in sector C. FIG. 6 shows a receiver arrangement of the base station BS of FIG. 5, comprising four receivers RX10, RX20, RX30 and RX40. Receiver RX10 includes three wideband radio parts RF11, RF12 and RF13, receiver RX20 includes radio parts RF21, RF22 and RF23, receiver RX30 includes radio parts RF31, RF32 and RF33, and receiver RX40 includes radio parts RF41, RF42 and RF43. In this example, the antennas are connected to the radio parts as follows: AA1 to RF11, AB1 to RF12, AC1 to RF12, AA2 to RF21, AB2 to RF22, AC2 to RF23, AA3 to RF31, AB3 to RF32, AC3 to RF33, AA4 to RF41, AB4 to RF42, and AC4 to RF43. Thus, each receiver has one antenna in each sector A, B and C. Receiver RX10 utilizes narrowband channel CH1, receiver RX20 utilizes narrowband channel CH2, receiver RX30 utilizes narrowband channel CH3, and receiver RX40 uses channel CH4, respectively. In this example, the radio parts RF11 to RF43 of the receivers are wideband, and according to the invention they receive at least one other narrowband channel in addition to the narrowband channel CH1, CH2, CH3 and CH4 used by the receiver. In other words, the radio parts RF11 to RF43 receive a wideband channel including four narrowband channels CH1, CH2, CH3 and CH4. The interconnections between the radio parts RF11 to RF43 and the baseband parts BB10, BB20, BB30 and BB40 can be performed via separate connections, but for the sake of clarity, the figure shows a bus BUS for transmitting the narrowband channels CH1, CH2, CH3 and CH4. Each radio part of each receiver usually transmits the channel used by the receiver to the baseband part of the receiver for further processing. According to a preferred embodiment of the invention, each radio part of each receiver transmits the narrowband channels used by other receivers to the baseband parts thereof for further processing. As a result, the baseband part BB10, BB20, BB30 or BB40 of each receiver receives twelve versions of the narrowband channel CH1, CH2, CH3 or CH4 it uses from different paths, i.e. it receives one version from each antenna, or four versions from each sector A, B and C. The example illustrates how the invention enables multiplying the number of reception paths of one receiver without having to increase the number of antennas or radio parts in the receiver.

It should be noted that the receiver arrangements used in the above examples are only illustrative embodiments of the invention. For example, the number of receivers or radio parts thereof can differ from the above examples.

It is evident to a person skilled in the art that as the technology develops, the basic idea of the invention can be implemented in various ways. Therefore, the invention and the embodiments thereof are not restricted to the examples described above, but they may vary within the scope of the claims

1. A reception method in a radio system comprising at least two receivers comprising a radio part and a baseband part, each receiver using a dedicated narrowband channel, the method comprising:
receiving, by the radio part of each receiver, the narrowband channel used by the receiver from the radio path;
forwarding the received narrowband channel from the radio part of the receiver to the baseband part for further processing;
receiving, by the radio part of at least one receiver, in addition to the narrowband channel used by the receiver, at least one narrowband channel other than that used by the receiver from the radio path; and
forwarding said at least one other narrowband channel from the radio part of said at least one receiver to the baseband part of at least one other receiver using said other narrowband channel for further processing.

2. The method of claim 1, the method comprising:
receiving each narrowband channel used by the system receivers from the radio path by the radio part of at least one receiver; and
forwarding each received narrowband channel from the radio part of said at least one receiver to the baseband part of the receiver using the channel in question for further processing.

3. The method of claim 1 or 2, wherein said further processing of the narrowband channel in the baseband part comprises channel demodulation.

4. The method of claim 1 or 2, wherein at least one of the receivers comprises at least two radio parts.

5. The method of claim 1 or 2, the method further comprising:
combining the narrowband channels for further processing in the baseband part of the receiver when two or more narrowband channels received via different paths are forwarded to the baseband part.

6. The method of claim 1 or 2, the method further comprising:
selecting the best narrowband channel for further processing in the baseband part of the receiver when two or more narrowband channels received via different paths are forwarded to the baseband part.

7. A radio system comprising:
at least two receivers comprising a radio part and a baseband part, each receiver being configured to use a dedicated narrowband channel, and the radio part of each receiver being configured to receive the narrowband channel used by the receiver from the radio path and to forward the received narrowband channel to the baseband part of the receiver for further processing, wherein
the radio part of at least one receiver is configured to receive in addition to the narrowband channel used by the receiver, at least one other narrowband channel in addition to the channel used by the receiver from the radio path, the system further comprising:
transmission means for forwarding said at least one other narrowband channel from the radio part of said at least one receiver to the baseband part of at least one other receiver using said other narrowband channel for further processing.

8. The system of claim 7, wherein the radio part of at least one receiver is adapted to receive each narrowband channel used by the system receivers from the radio path, the system further comprising:
transmission means for forwarding each of said narrowband channels from the radio part of said at least one receiver to the baseband part of the receiver using said channel for further processing.

9. The system of claim 7 or 8, wherein said further processing of the narrowband channel in the baseband part comprises channel demodulation.

10. The system of claim 7 or 8, wherein at least one receiver comprises at least two radio parts.

11. The system of claim 7 or 8, wherein the baseband part of the receiver is configured to combine the narrowband channels for further processing when two or more narrowband channels received via different paths are forwarded to the baseband part.

12. The system of claim 7 or 8, wherein the baseband part of the receiver is configured to select the best narrowband channel for further processing when two or more narrowband channels received via different paths are forwarded to the baseband part.

13. A receiver in a radio system comprising at least two receivers comprising a radio part and a baseband part, each receiver being configured to use a dedicated narrowband channel, and the radio part of the receiver being configured to receive the narrowband channel used by the receiver from the radio path and to forward the received narrowband channel to the baseband part of the receiver for further processing, wherein:
the radio part of the receiver is configured to receive in addition to the narrowband channel used by the receiver, at least one other narrowband channel in addition to the channel used by the receiver from the radio path; and
the receiver is configured to forward said at least one other narrowband channel from the radio part of the receiver to the baseband part of at least one other radio system receiver using said other narrowband channel for further processing.

14. The receiver of claim 13, wherein the wideband radio part of the receiver is configured to receive each narrowband channel used by the radio system receivers from the radio path and to forward each of said narrowband channels from the radio part of the receiver to the baseband part of the other receiver using said channel for further processing.

15. The receiver of claim 13 or 14, the receiver comprising at least two radio parts.

16. The receiver of claim 13 or 14, wherein the baseband part of the receiver is configured to combine the narrowband channels for further processing when two or more narrowband channels received via different paths are forwarded to the baseband part.

17. The receiver of claim 13 or 14, wherein the baseband part of the receiver is configured to select the best narrowband channel for further processing when two or more narrowband channels received via different paths are forwarded to the baseband part.
